(19) United States
(12) Patent Application Publication
(10) Pub. No.: US 2009/0160317 A1
(43) Pub. Date: Jun. 25, 2009

(54) INCREASING THE EXTERNAL EFFICIENCY OF ORGANIC LIGHT EMITTING DIODES UTILIZING A DIFFRACTION GRATING

(76) Inventor: Herschel Clement Burstyn, Lawrenceville, NJ (US)

Correspondence Address: FOLEY & LARDNER LLP, 150 EAST GILMAN STREET, P.O. BOX 1497, MADISON, WI, 53701-1497, US

(21) Appl. No.: 11/963,026

(22) Filed: Dec. 21, 2007

(51) Int. Cl. H01J 1/63; H01J 9/02

(52) U.S. Cl. 313/504; 445/35

(57) ABSTRACT

The present disclosure relates to increasing the external efficiency of light emitting diodes, and specifically to increasing the outcoupling of light from an organic light emitting diode utilizing a diffraction grating.

### TECHNICAL FIELD

The present disclosure relates to increasing the external efficiency of light emitting diodes, and specifically to increasing an outcoupling of light from an organic light emitting diode utilizing a diffraction grating.

### BACKGROUND

Typically an organic light-emitting diode (OLED) is a type of light-emitting diode (LED) in which the emissive layer often comprises a thin-film of certain organic compounds. The emissive electroluminescent layer can include a polymeric substance that allows the deposition of very suitable organic compounds, for example, in rows and columns on a flat carrier by using a simple “printing” method to create a matrix of pixels which can emit different coloured light. Such systems can be used in television screens, computer displays, portable system screens, advertising and information, indication applications, etc. OLEDs can also be used in light sources for general space illumination. OLEDs typically emit less light per area than inorganic solid-state based LEDs which are usually designed for use as point light sources.

One of the benefits of an OLED display over the traditional LCD displays is that OLEDs typically do not require a backlight to function. This means that they often draw far less power and, when powered from a battery, can operate longer on the same charge. It is also known that OLED-based display devices can often be more effectively manufactured than liquid-crystal and plasma displays.

Prior to standardization, OLED technology was also referred to as Organic Electro-Luminescence (OEL).

As illustrated by FIG. 1, an Organic LED 100 typically includes an organic layer (or layers) 130 in addition to the substrate 110, anode 120 and cathode 140. When multiple organic layers are used, two of the layers are typically called the Emissive and the Conductive layers. Both these layers are frequently made up of organic molecules or polymers. These selected compounds are typically labeled as Organic Semiconductors and certain conductivity levels are shown by these compounds ranging between those of insulators and conductors.

OLEDs often emit light in a similar manner to LEDs, through a process called electrophosphorescence. As the voltage is applied across the OLED such that the anode has a positive voltage with respect to the cathode, a current starts flowing through the device. The direction of conventional current flow is from anode to cathode, hence electrons flow from cathode to anode. Thus, the cathode gives electrons to the emissive layer and the anode withdraws electrons from the conductive layer (in essence, it is same as the anode giving holes to the conductive layer).

Hence, after a short time period, the emissive layer will typically become rich in negatively charged electrons while the conductive layer has an increased concentration of positively charged holes. Due to natural affinity for unlike charges, these two are attracted to each other. It is to be noted here that in organic semiconductors, in contrast to the inorganic semiconductors, the hole mobility is often greater than the mobility of electrons. Hence, as the two charges move towards each other, it is more likely that their recombination will occur in the emissive layer. Due to this recombination, there is an accompanying drop in the energy levels of the electrons and this drop is characterized by the emission of radiation with a frequency lying in the visible region, viz. light is produced. That is the reason behind this layer being called the emissive layer.

As a diode, typically the device will not work when the anode is put at a negative potential, with respect to the cathode. This is because in this condition, the anode will pull holes towards itself and the cathode will pull the electrons. Therefore, the electrons and holes are moving away from each other and will not recombine.

The external efficiency of current organic light emitting diodes (OLEDs) is frequently low. Most of the radiated light is trapped by total internal reflection in the organic layer and the anode layer, which have often higher indexes of refraction than the substrate and the surrounding air. As shown in FIG. 1, only light emitted nearly perpendicular to the layers can easily escape (paths 191 & 192). Light emitted away from perpendicular is not likely to escape. Depending on the direction of emission, the light may be trapped at the substrate-air interface (path 193), at the anode-substrate interface (path 194) or at the organic-cathode interface as a surface Plasmon (path 195). It has been estimated that about 50% of the emitted light of an OLED goes into a surface plasmon mode. Light that does not escape is ultimately absorbed within the structure.

### BRIEF DESCRIPTION OF THE DRAWINGS THE DISCLOSURE

FIG. 1 is a schematic diagram illustrating an embodiment of an organic light emitting diode;

FIG. 2 is a schematic diagram illustrating an embodiment of an organic light emitting diode in accordance with the disclosure;

FIG. 3 is a schematic diagram illustrating an embodiment of an organic light emitting diode in accordance with the disclosure;

FIG. 4 is a block diagram illustrating an embodiment of an apparatus and a system in accordance with the disclosure.

### DETAILED DESCRIPTION

In the following detailed description, numerous details are set forth in order to provide a thorough understanding of several embodiments. However, it will be understood by those skilled in the art that other embodiments may be practiced without these specific details. In other instances, well-known methods, procedures, components, and circuits have not been described in detail so as to not obscure claimed subject matter.

In the following detailed description, reference is made to the accompanying drawings which form a part hereof, and in which is shown by way of illustration embodiments in which the invention may be practiced. It is to be understood that other embodiments may be utilized and structural or logical changes may be made without departing from the scope of the disclosure. Therefore, the following detailed description is not to be taken in a limiting sense.

Various operations may be described as multiple discrete operations in turn, in a manner that may be helpful in understanding the disclosure; however, the order of description should not be construed to imply that these operations are order dependent.

For the purposes of the description, a phrase in the form “A/B” means A or B. For the purposes of the description, a phrase in the form “A and/or B” means “(A), (B), or (A and B)”. For the purposes of the description, a phrase in the form “at least one of A, B, and C” means “(A), (B), (C), (A and B), (A and C), (B and C), or (A, B and C)”. For the purposes of the description, a phrase in the form “(A)B” means “(B) or (AB)” that is, A is an optional element.

For purposes of the description, a phrase in the form “below”, “above”, “to the right of”, etc. are relative terms and do not require that the disclosure be used in any absolute orientation.

For ease of understanding, the description will be in large part presented in the context of display technology; however, the present invention is not so limited, and may be practiced to provide more relevant solutions to a variety of illumination needs. Reference in the specification to a processing and/or digital “device” and/or “appliance” means that a particular feature, structure, or characteristic, namely device operable connectivity, such as the ability for the device to execute or process instructions and/or programmability, such as the ability for the device to be configured to perform designated functions, is included in at least one embodiment of the digital device as used herein. According to one embodiment, digital devices may include general and/or special purpose computing devices, connected personal computers, network printers, network attached storage devices, voice over internet protocol devices, security cameras, baby cameras, media adapters, entertainment personal computers, and/or other networked devices suitably configured for practicing the disclosure in accordance with at least one implementation; however these are merely a few examples of processing devices to which the disclosure is not limited.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

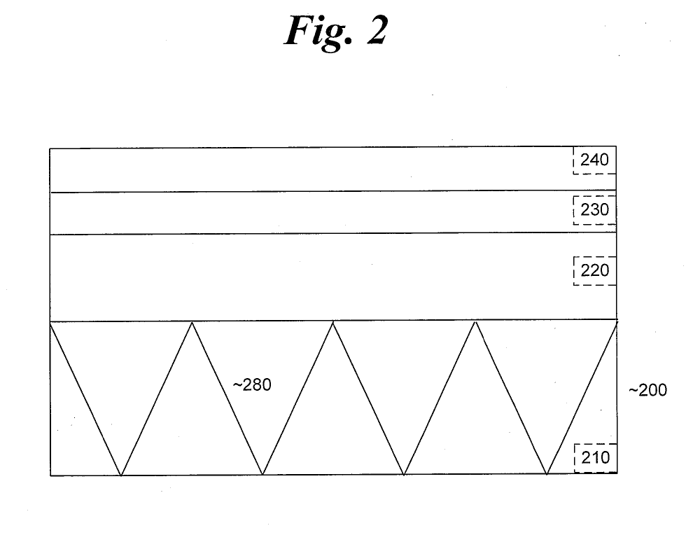

FIG. 2 is a schematic diagram illustrating an embodiment of an organic light emitting diode (OLED) 200 in accordance with the disclosure. The OLED may include a plurality of layers, such as, for example, a substrate 210, an anode layer 220, an organic layer 230, and a cathode layer 240. FIG. 2 illustrates a bottom-emitter OLED, as light is emitted through the substrate. Other embodiments, of the disclosure may include other forms of OLEDs (not shown), such as, for example, top-emitter OLEDS (where light is emitted though a cover), a transparent OLED (where it is possible to emit light through both the top and bottom of the device), a foldable OLED (where substrates may include a very flexible metallic foil or plastics), passive-matrix OLEDs (where strips of the cathode, anode, and organic layers may be used), or active-matrix OLEDs (where often a thin film transistor array is overlayed onto the typical OLED layers), etc. In one embodiment, the organic layer(s) of the OLED may be between 100 to 500 nanometers (nm) thick.

In one embodiment the substrate 210 may include glass, plastic, a thin film, ceramic, a semi-conductor, or a foil. Here, this substrate may be substantially optically clear, although in other embodiments an opaque material may be used. In one embodiment the substrate may be approximately 1 millimeter (mm) thick and include an index of refraction of approximately 1.45. In one embodiment, the substrate may be capable of supporting at least one of the other layers of the LED.

In one embodiment, the anode 210 may remove electrons (i.e. adds electron “holes”) when current flows through the device. In the case of the bottom-emitting OLED illustrated in FIG. 2, the anode may be substantially transparent. In some embodiments, transparent anode materials may include indium-tin oxide (ITO), indium-zinc oxide (IZO), and/or tin oxide, but other metal oxides may be used, such as, for example, aluminum- or indium-doped zinc oxide, magnesium-indium oxide, and nickel-tungsten oxide. In addition to these oxides, metal nitrides, such as gallium nitride, and metal selenides, such as zinc selenide, and metal sulfides, such as zinc sulfide, may be used as the anode in various embodiments. In other embodiments, the transmissive characteristics of the anode may be immaterial and any conductive material may be used, such as transparent, opaque or reflective materials, for example. Example conductors for these embodiments may include, but are not limited to, gold, iridium, molybdenum, palladium, and platinum. In one embodiment, the anode layer may be approximately 200 nanometers thick, and have an index of refraction of 2.

In one embodiment, the organic layer 220 may include sub-layers comprising conductive and emissive layers, and, in some embodiments, a third or fourth organic layer. For this reason, the organic layer is sometimes referred to as the organic stack. These organic layers are often made of organic molecules or polymers. In one embodiment, the organic layer may be approximately 100-500 nanometers thick, and have an index of refraction of 1.72.

In one embodiment, the conducting layer may be made of organic plastic molecules that transport “holes” from the anode. One conducting polymer used in OLEDs is polyaniline, although that is merely one non-limiting embodiment of the disclosure. The following are a few illustrative examples of possible materials that may be used various embodiments of the disclosure: aromatic tertiary amines, polycyclic aromatic compounds, and polymeric hole-transporting materials.

In one embodiment, the emissive layer may be made of organic plastic molecules (different ones from the conducting layer) that transport electrons from the cathode and electroluminescence is produced as a result of electron-hole pair recombination. One polymer used in some embodiments of the emissive layer is polyfluorene, although that is merely one non-limiting embodiment of the disclosure.

A light-emitting layer can be comprised, in one embodiment, of a single material. In other embodiments, such a light emitting layer may consist of a host material doped with a guest compound or compounds where light emission comes primarily from the dopant and can be of any colour. Various dopants may be combined to produce colours. In one embodiment, this technique may be used to produce a white OLED. In one embodiment, dopants may be chosen from highly florescent dyes. In other embodiments, dopants may include phosphorescent compounds. The following are a few illustrative examples of possible materials that may be used as host materials in various embodiments of the disclosure: tris(8-quinolinolato)aluminum(III) (Alq3), metal complexes of 8-hydroxyquinoline (oxine) and similar derivatives, derivatives of anthracene, distyrylarylene derivatives, benzazole derivatives, or carbazole derivatives.

In various embodiments, the conducting layer and emissive layer may include a single layer. In versions of these embodiments, the emissive dopants may be added to a hole-transporting material.

In other embodiments, the organic layer 230 may also comprise sub-layers such as additional organic layers. In one embodiment, a hole-injecting layer may be added below or as part of the conductive layer. The hole-injecting layer, in one embodiment, may serve to improve the film formation property of subsequent organic layers and to facilitate injection of holes into the conductive layer. In another embodiment, an electron-transporting layer may be included above the emissive layer. The electron-transporting layer may, in one embodiment, help to inject and transport electrons.

In one embodiment, the cathode 240 may provide electrons (i.e. removes electron “holes”) when current flows through the device. In the case of the bottom-emitting OLED illustrated in FIG. 2, the cathode may be substantially opaque. However, in other embodiments, it may be desirable to utilize a transparent cathode. In some embodiments, cathode materials may include a lithium fluoride (LiF) layer backed by an aluminum (Al) layer, Magnesium/Silver (Mg:Ag), metal salts, or other transparent cathodes.

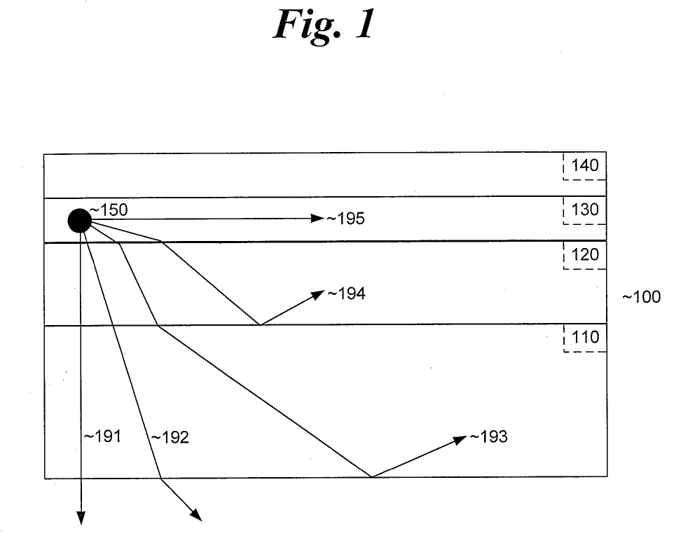

As illustrated by FIG. 1, a large portion of the light emitted by the organic layer does not leave the LED. A technique to recover this lost light is to scatter the light that emits in an unfavourable direction to a more favourable direction. Such a favourable direction would allow the light to escape the LED structure. To scatter light that would not escape (e.g. paths 193, 194, & 195) to a direction that allows it to escape (e.g. paths 191 & 192) may include the use of a diffraction grating.

Referring to FIG. 2, in one embodiment, a diffraction grating 280 may be formed within or as part of the substrate 210. In one embodiment, this diffraction grating may be a relief grating. In one embodiment, a 2-dimensional diffractive array may be formed by a film of pyramid-like structures. In another embodiment, a diffraction pattern may be made by inducing index differences. As the light reflects off or transmits through the diffraction grating it is likely to be outcoupled and therefore more likely to be emitted from the LED as opposed to being trapped within the LED and eventually absorbed.

For, example, the period of the diffraction grating may be determined so that the diffraction grating may operate to increasingly be diffractive rather than refractive. In one embodiment, a leaky-wave coupler may comprise a 2-dimensional diffraction grating, implemented as two substantially orthogonal 1-dimensional gratings. In one embodiment, the grating equation below expresses the boundary phase matching condition.

$$sin Θ = \frac{λ}{{λ}_{g}} - m \frac{λ}{d}$$

Where λ is the wavelength of the light in air, λ_{g} is the wavelength of the light in the wave guide, m is an integer, d is the period of the diffraction grating, and Θ is the emission angle of the light into the air. Using such an equation may allow, in one embodiment, the period of the diffraction grating to be determined. For example, using such an equation may allow, in one embodiment, the diffraction grating to yield a wave that may be nominally in a direction normal to the diffraction grating.

In one embodiment, the diffraction grating may be a planarized phase grating. In one embodiment, as shown in FIG. 2, the grating may be on top of or within the substrate. One example may be in embodiments where the light is emitted through the substrate. In another embodiment, the grating may be formed below or within a cover (not shown). Examples of such embodiments, may include, but are not limited to, top emitter diodes, transparent OLEDs, etc.

In one embodiment, the substrate's diffraction grating may be formed by utilizing heavy ion implantation, such as, for example, soaking a photographically developed glass plate in salt. In other embodiments, photonic crystal may be developed by etching, which may form, at least conceptually, a form of surface relief grating.

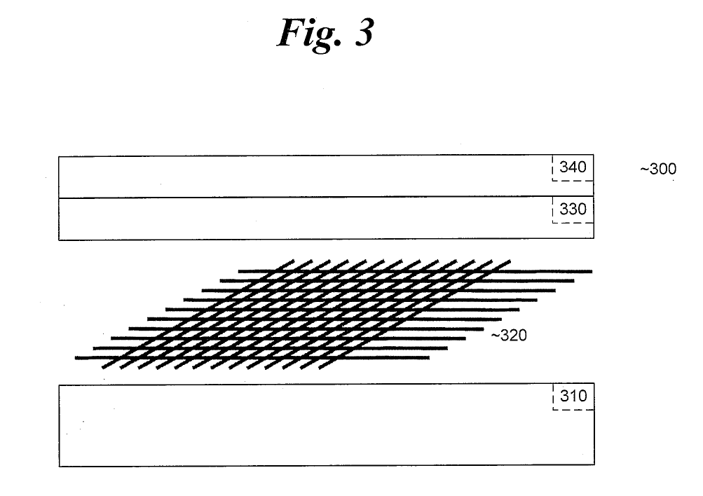

The other layers of the LED may be applied or added on top of the substrate. It is contemplated that in various embodiments the layers may be formed separately and added to the substrate individually or as a preformed group. In one embodiment, these layers may be applied in order to form an embodiment of the LED illustrated in FIG. 2. In another embodiment, the layers may be applied in order to form an embodiment of the LED illustrated in FIG. 3.

In one embodiment, some of the layers may be applied using a technique known as or substantially similar to vacuum deposition or vacuum thermal evaporation (VTE). In one embodiment of vacuum deposition, a vacuum chamber, the organic molecules are gently heated (evaporated) and allowed to condense as thin films onto cooled substrates.

In another embodiment, some of the layers may be applied using a technique known as or substantially similar to organic vapor phase deposition (OVPD). In one embodiment of organic vapor phase deposition, in a low-pressure, hot-walled reactor chamber, a carrier gas transports evaporated organic molecules onto cooled substrates, where they condense into thin films. Using a carrier gas may increase the efficiency and reduces the cost of making OLEDs.

In yet another embodiment, some of the layers may be applied using a technique known as or substantially similar to splattering or inkjet printing. In one embodiment, splattering may include spraying the layers onto substrates just like inks are sprayed onto paper during printing. Inkjet technology may greatly reduce the cost of OLED manufacturing and allow OLEDs to be printed onto very large films for large displays like 80-inch TV screens or electronic billboards.

It is contemplated that some or all of these techniques may be used to make or manufacture an embodiment of the disclosed subject matter. In other embodiments other techniques may be used. It is also contemplated that the manufacture of these embodiments may be automated.

FIG. 3 is a schematic diagram illustrating an embodiment of an organic light emitting diode in accordance with the disclosure. Elements 300, 310, 330, and 340 may be analogous to elements 200, 210, 230, and 240, respectively, of FIG. 2 described above. In one embodiment, element 320 of FIG. 3 may be roughly analogous with element 220 of FIG. 2. However, in one embodiment, the anode layer may be a regular array of conductors forming a diffractive grating, as opposed to a substantially solid layer. In one embodiment, the fringing fields may be perturbed by such a periodic change in the optical index, allowing light to be outcoupled from the OLED. In another embodiment, the cathode may be formed from, or into, a diffractive grating. In yet another embodiment, both the anode and cathodes may be a diffractive grating.

In one embodiment, the conductors may be made from micro-wires. In one embodiment, the micro-wires may form a polarizer. The wires may be periodically spaced so as to form a pattern similar to that seen on graph paper. In another embodiment, the pattern may be similar to a circuit board ground plane.

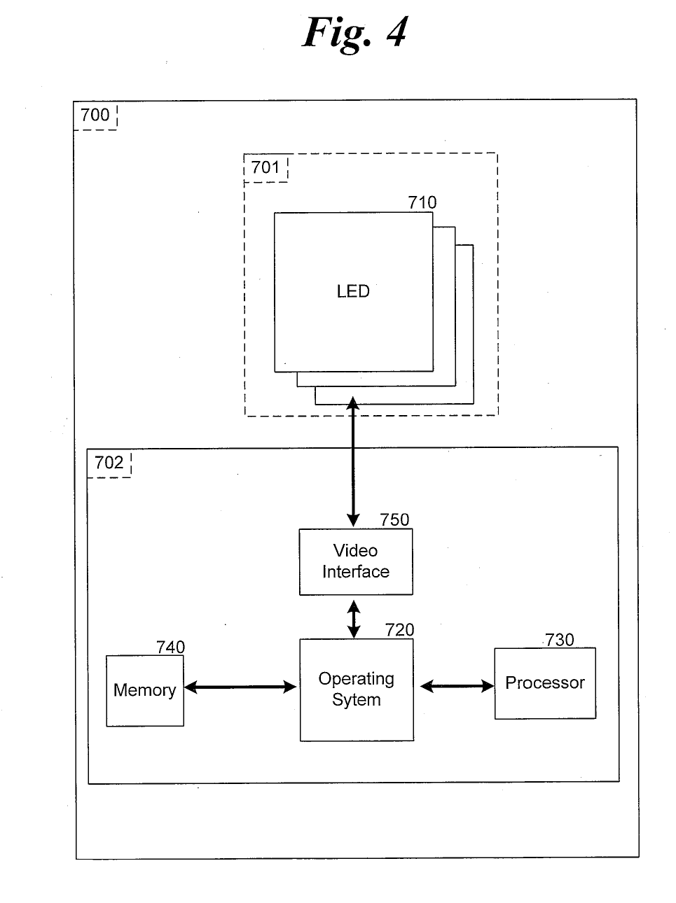

FIG. 4 is a block diagram illustrating an embodiment of an apparatus 710 and a system 700 in accordance with the disclosure. In one embodiment, the system may include a display 701 and a processing device 702. In one embodiment, the display and processing device may be integrated, such as, for example a media device, a mobile phone, or other small form factor device.

In one embodiment, the display 701 may include at least one LED as illustrated by FIGS. 2 & 3 and discussed in detail above. In other embodiments the LEDs may include other forms of LEDs which are not bottom-emitting LEDs but include some of the features of the LEDs described above.

In one embodiment, the processing device 702 may include an operating system 720, a video interface 750, a processor 730, and a memory 740. In one embodiment, the operating system may be capable of facilitating the use of the system and generating a user interface. The processor 730 may be capable of, in one embodiment, executing or running the operating system. The memory 740 may be capable of, in one embodiment, storing the operating system. The video interface 750 may, in one embodiment, be capable of facilitating the display of the user interface and interacting with the display 701. In one embodiment, the video interface may be included within the display.

The techniques described herein are not limited to any particular hardware or software configuration; they may find applicability in any computing or processing environment. The techniques may be implemented in hardware, software, firmware or a combination thereof. The techniques may be implemented in programs executing on programmable machines such as mobile or stationary computers, personal digital assistants, and similar devices that each include a processor, a storage medium readable or accessible by the processor (including volatile and non-volatile memory and/or storage elements), at least one input device, and one or more output devices. Program code is applied to the data entered using the input device to perform the functions described and to generate output information. The output information may be applied to one or more output devices.

Each program may be implemented in a high level procedural or object oriented programming language to communicate with a processing system. However, programs may be implemented in assembly or machine language, if desired. In any case, the language may be compiled or interpreted.

Each such program may be stored on a storage medium or device, e.g. compact disk read only memory (CD-ROM), digital versatile disk (DVD), hard disk, firmware, non-volatile memory, magnetic disk or similar medium or device, that is readable by a general or special purpose programmable machine for configuring and operating the machine when the storage medium or device is read by the computer to perform the procedures described herein. The system may also be considered to be implemented as a machine-readable or accessible storage medium, configured with a program, where the storage medium so configured causes a machine to operate in a specific manner. Other embodiments are within the scope of the following claims.

While certain features of the disclosure have been illustrated and described herein, many modifications, substitutions, changes, and equivalents will now occur to those skilled in the art. It is, therefore, to be understood that the appended claims are intended to cover all such modifications and changes that fall within the true spirit of the disclosure.

1. An apparatus comprising:
a light emitting diode (LED) including:
an emissive layer capable of emitting light, and
a diffraction grating capable of enabling the emitted light to escape from the LED.

2. The apparatus of claim 1, wherein the light emitting diode includes an organic light emitting diode.

3. The apparatus of claim 1, wherein the diffraction grating includes a planarized phase grating.

4. The apparatus of claim 3, wherein the planarized phase grating includes a multi-dimensional diffractive array comprising substantially pyramid structures.

5. The apparatus of claim 4, wherein the planarized phase grating is relief etched into a substrate, and the light emitting diode includes the substrate.

6. The apparatus of claim 4, wherein the planarized phase grating is relief etched into a cover, and the light emitting diode includes the cover.

7. The apparatus of claim 6, wherein the etching is accomplishing utilizing, at least in part, heavy ion implantation.

8. The apparatus of claim 3, wherein the planarized phase grating includes a multi-dimensional diffractive array comprising periodic differences in the index of refraction.

9. The apparatus of claim 1, wherein the diffraction grating includes a substantially rectangular array of conductors.

10. The apparatus of claim 1, wherein the light emitting diode includes a conductor; and wherein the conductor includes a periodic structure of conductive strips.

11. The apparatus of claim 10, wherein the conductor includes a substantially infinite index of refraction.

12. The apparatus of claim 10, wherein the conductor is arranged in a quadrilateral array.

13. The apparatus of claim 10, wherein period of the strips is such so as to attempt to aid the outcoupling of light from the light emitting diode.

14. The apparatus of claim 13 wherein period is determined utilizing, at least in part, the equation:
$$sin Θ = \frac{λ}{{λ}_{g}} - m \frac{λ}{d}$$
wherein λ is the wavelength of the light in air, λ_{g} is the wavelength of the of the light in the light emitting diode, m is an integer, d is the period of the diffraction grating, and Θ is the emission angle of the light in the air.

15. A system comprising:
an operating system capable of facilitating the use of the system, and generating a user interface;
a processor capable of running the operating system; and
a display capable of displaying the user interface, and
including at least one light emitting diode (LED) having:
an emissive layer capable of emitting light,
a diffraction grating capable of enabling the emitted light to escape from the LED, wherein the diffraction grating comprises a periodic structure determined utilizing, at least in part, the equation:
$$sin Θ = \frac{λ}{{λ}_{g}} - m \frac{λ}{d}$$
wherein λ is the wavelength of the light in air, λ_{g} is the wavelength of the of the light in the light emitting diode, m is an integer, d is the period of the diffraction grating, and Θ is the emission angle of the light in the air.

16. The system of claim 15, wherein the diffraction grating includes a multi-dimensional diffractive array comprising substantially pyramid structures.

17. The system of claim 15, wherein the light emitting diode includes a conductor; and wherein the conductor includes a periodic structure of conductive strips arranged to form the diffraction grating.

18. A light emitting diode (LED) comprising:
an emissive means for emitting light, and
a diffraction means for directing the scattering of light emitted by the emissive means, and for enabling the emitted light to escape from the LED, wherein the diffraction means comprises a periodic structure determined utilizing, at least in part, the equation:
$$sin Θ = \frac{λ}{{λ}_{g}} - m \frac{λ}{d}$$
wherein λ is the wavelength of the light in air, λ_{g} is the wavelength of the of the light in the light emitting diode, m is an integer, d is the period of the diffraction means, and Θ is the emission angle of the light in the air.

19. The light emitting diode of claim 18, wherein the diffraction means further comprises a conductor means for providing electrons when current flows through the LED.

20. A method of constructing an organic light emitting diode (OLED) comprising:
forming a substrate layer;
forming a first and a second conductor layer;
forming an emissive layer capable of emitting light; and
causing a diffraction grating to be formed in either the substrate layer or the first conductor layer, wherein the diffraction grating is capable of facilitating the outcoupling of light emitted by the emissive layer from the OLED.

21. The method of claim 20, wherein causing a diffraction grating to be formed includes causing a periodic grating of pyramid structures to be formed within the substrate layer.

22. The method of claim 21, wherein causing a periodic grating includes etching the substrate layer.

23. The method of claim 22, wherein etching includes utilizing heavy ion implantation.

24. The method of claim 20, wherein causing a diffraction grating to be formed includes causing a periodic difference in the index of refraction of the substrate to be formed within the substrate layer.

25. The method of claim 20, wherein causing a diffraction grating to be formed includes forming the first conductor such that the first conductor includes a periodic structure of conductive strips arranged to form the diffraction grating.

26. The method of claim 25, wherein the periodic structure of conductive strips includes a substantially quadrilateral array of conductive strips.

27. The method of claim 25, wherein the first conductor is an anode and the second conductor is a cathode.

28. The method of claim 25, wherein the diffraction grating is capable of outcoupling light due to, at least in part, the periodic change in the index of refraction between the first conductor and the other layers of the OLED.

29. The method of claim 20, wherein the substrate layer includes glass, and the first conductor includes a layer of indium tin oxide (ITO).
